(19) United States
(12) Patent Application Publication
(10) Pub. No.: US 2005/0179808 A1
(43) Pub. Date: Aug. 18, 2005

(54) Image capturing device and method with negative out of focus module

(75) Inventor: Shih Yang Lee, Hsin-Chu City (TW)

Correspondence Address: SQUIRE, SANDERS & DEMPSEY L.L.P, 600 HANSEN WAY, PALO ALTO, CA, 94304-1043, US

(73) Assignee: Lite-On Technology Corporation, Taipei City (TW)

(21) Appl. No.: 10/771,274

(22) Filed: Feb. 2, 2004

(51) Int. Cl. H04N 5/232

(52) U.S. Cl. 348/345

(57) ABSTRACT

The present invention provides an image-capturing device with negative out of focus module. The negative out of focus module is according to the design aperture within the image-capturing device to estimate the range of the depth of the field. Then, continuing to capture the object to obtain the number of image, which can contain the whole range of the depth of field while moving the length of the focus. Herein, the range of the depth of the field can be obtained from the short focus length to the infinite focus length. Thus, at least one photograph can show the clearly object from the number of image by continuing to capture the object.

### BACKGROUND OF THE INVENTION

1. Field of the Invention

The present invention generally related to an image-capturing device and the method thereof, and more particularly to an image-capturing device with negative out of focus function and the method thereof.

2. Description of the Prior Art

In mainly, the image-capturing device will estimate a required exposure value (EV) to capture the image, when the image-capturing device with self-motion focus used to capture the image (human being, building, or scenery). In generally, the built-in arithmetic unit can estimate the accurate exposure value to capture the image. However, the image-capturing device cannot automatically to estimate which image is to be captured (background or human being). Thus, the image-capturing device only estimates the focal length to capture the image, such that the photograph would be showed the indistinct image of the object, but the background object is clearly.

As FIG. 1, which illustrates the flow chart of the automatic focus image-capturing device that used to capture the image. Block 101 illustrates that user selects the scenery or building as the background object for capturing; block 102 illustrates the user invites another tourist or negative people to assist to capture the image of the topic object; and block 103 illustrates the image-capturing device will execute the automatic focus function during capturing process. The image would have two results after capturing process, one is that both of the topic object and the background object are showed clearly in the photograph (block 104); another is that the image is out of focus such that the topic object is indefinite in the photograph (block 105). Thus, the photograph did not have any worth to reserve.

### SUMMARY OF THE INVENTION

To reduce the failure in photographing, an image-capturing device with negative out of focus module is provided. With capturing multitudes of sequent photos that have the range of depth of field overlap each another, the out of focus during the capturing process is improved.

An image-capturing device and method thereof with negative out of focus is provided herein. Multitudes of photos are automatically captured by using an exposure value with different focal length, such that the topic object can be captured and showed the clearly image of the topic object in the photograph.

According to abovementioned objects, the present invention provides a negative out of focus module within the image-capturing device. The negative out of focus module is according to the original exposure value of the automatic focus image-capturing device to calculate the depth of field. Then, moving the focus length to continuous capture the topic object to obtain the number of the photograph, which can contains the overall the depth of filed, which includes the short distance to the infinite of the depth of field. Thus, the number of photographs can provide at least one photograph to show a clearly topic object.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow diagram showing the steps for capturing the image of topic object to make the out of focus problem using conventional, prior art techniques;

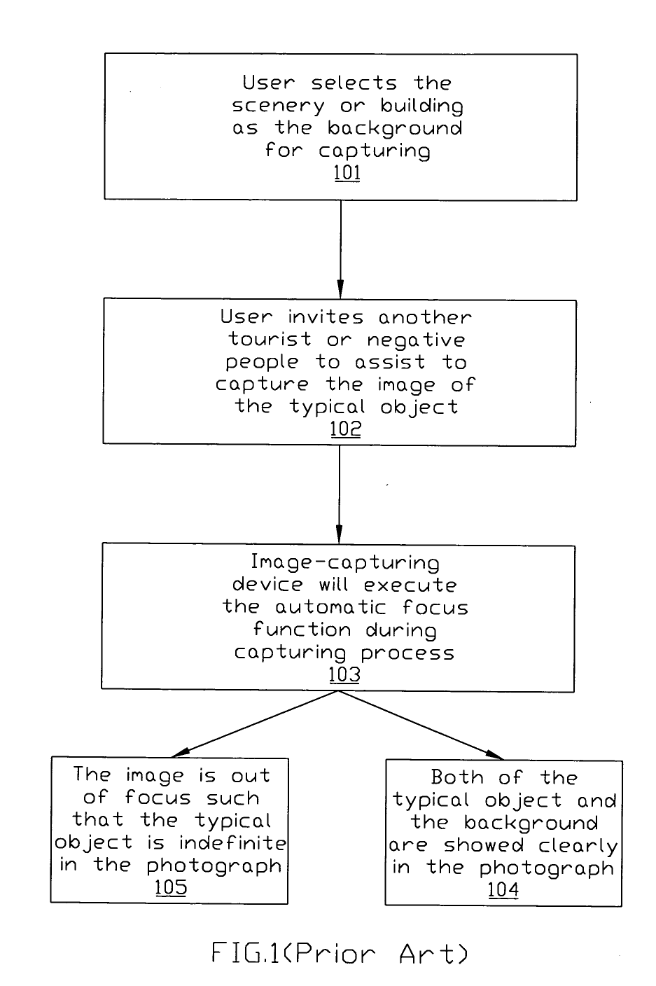

FIG. 2 is a flow diagram showing the steps for capturing the image of topic object by using image-capturing device with negative out of focus module in accordance with the method disclosed herein;

FIG. 3A to FIG. 3C are schematic representation the method for capturing the image of topic object by using the image-capturing device with negative out of focus module; and

FIG. 4 is a schematic block diagram illustrating an image-capturing apparatus in accordance with the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

According to the capturing process for the typical automatic focus image-capturing device is utilized the built-in arithmetic unit to estimate to obtain an exposure value (EV). However, the image-capturing device cannot determine which the topic object to be captured is. Therefore, the present invention provides a method for improving the out of focus for image-capturing device, and also provides a negative out of focus module within the image-capturing device to solve the drawback in the background object (block 105). Thus, the important photograph can be retained and the photograph can show the clearly topic object.

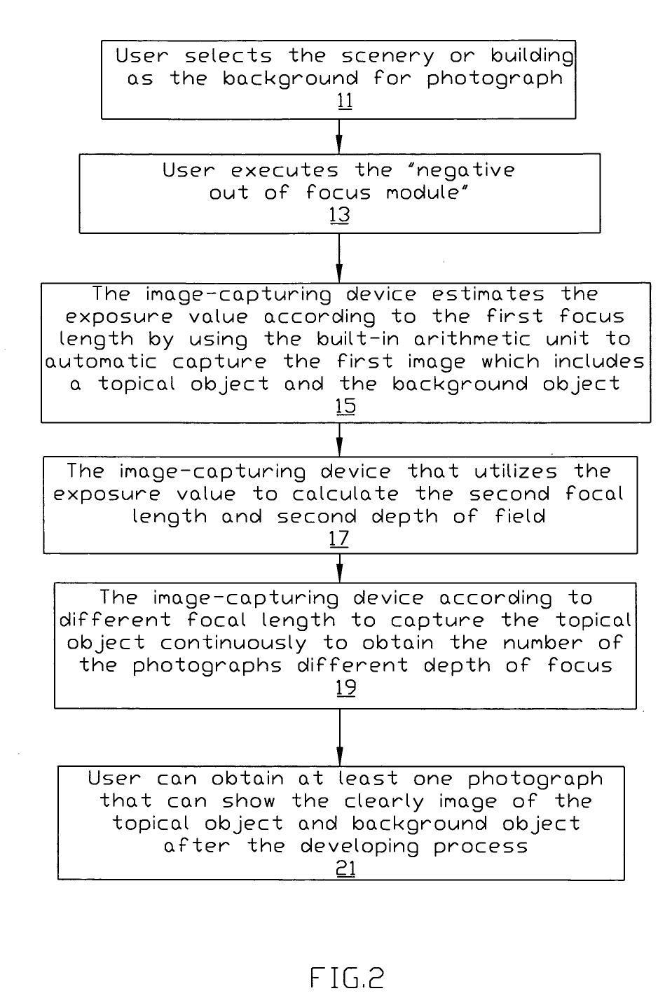

FIG. 2 illustrates the flow chart for the image-capturing device with negative out of focus module. Block 11, illustrates that user utilize the image-capturing device such as a view window of automatic camera to select the topic object for capturing. In an embodiment, the capturing object includes topic object and background. The topic object, such as human being, which stands near the camera, and the background object, such as mountain or building, which is far away the camera. The distance between the topic object and the background object is very large, but the embodiment is not in this limitation.

Block 13 illustrates that user executes the “negative out of focus module” and capture the image by utilize the image-capturing device. Herein, the “capture” is meaning that an image of the object is recoded in materialization. For conventional camera used the negative of a photo to sense the light to record the image. Else, for the digital camera, the image is stored in the memory. Furthermore, the automatic camera will calculate an optima exposure value according to the built-in sensitive light system. In general, the exposure value is obtained by computing the aperture value and the camera shutter.

Then, in block 15, with processing based on an object distance (i.e. the distance between the lens of the image-capturing device and a background object), the image-capturing device automatically captures a photo including a topic and the background objects. Lens with a first focal length is utilized and associated with a first depth of field and a corresponding exposure value, according to the objective distance. Block 17 illustrates the image-capturing device that utilizes the exposure value to calculate the second focal length and second depth of field, wherein the partial portion of second depth of field overlaps the partial portion of first depth of field. Thus, the focal length of the image, which is captured by the second focal length that is within the first depth of field, and covered by the first depth of field.

Then, block 19 illustrates the image-capturing device according to different focal length to capture the topic object continuously to obtain the number of the photographs different depth of focus. Therefore, the number of photographs can includes the overall the depth of field that between the topic object and the background. Therefore, the user can obtain at least one photograph that can show the clearly image of the topic object and background object after the developing process (block 21).

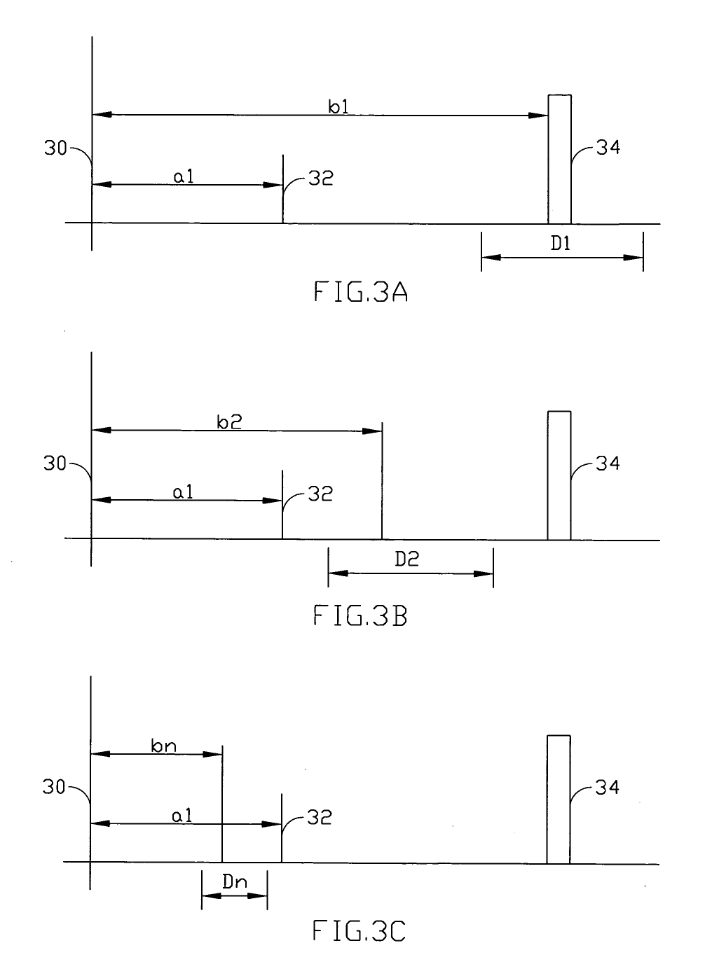

FIG. 3A to FIG. 3C illustrate the method for the image-capturing device with negative out of focus capturing the topic object to obtain the photograph to show the clearly image of the topic object. When the people (user) travel in the scenery, especially in aboard, the most tourists will select the beautiful scenery or building as the background object to capture to memory for the travel. At this time, the image-capturing device user would like to request the negative or other tourist to capture the image.

For example, image-capturing device 30 finds a view in which the Tokyo tower is used as the background object 34, and people used as a topic object 32. Generally, the focusing area of the lens encircles and focuses on the background object 34. Thus, the exposure value can be automatically acquired by the arithmetic unit within the image-capturing device 30. For example, the aperture is 5.6 and the camera shutter is 1/125 second. Shown in FIG. 3A, b1 represents the distance between the lens of image-capturing device 30 and the background object 34; a1 is the distance between the lens of image-capturing device 30 and the topic object 32. It is noted that b1 is the actual distance in focus for the first time capturing, however, a l is the desirable distance in focus for the user. The depth of field “D1” according to “b1” only encloses the around of the Tokyo tower 34. Thus, the topic object 32 would be demonstrated out of focus in the photograph that after developing process.

It should be appreciated that the definition of topic object 32 is depended on the depth of field within which the image on film is definitely demonstrated. Therefore, beside the depth of field, aperture, the focus length of lens, and focus length are very important factory for image definition. It also should be appreciated that the shorter the focal length of the lens used and the farther the distance of the topic object are, the more the depth of field is.

According to abovementioned, in order to solve the drawback for the indefinite image of the topic object 32, a “negative out of focus module” can execute before capturing process. Depicted in FIG. 3A, “a1” represents the distance between the image-capturing device 30 and the topic object 32. For the object distance “b1” between the image-capturing device 30 and the background object 34, the image-capturing device 30 captures first time with lens of first focal length and an associated exposure vale. According, “D1” represents the first depth of filed. Next, the desired second focal length is acquired based on the identical exposure value. Thus, the second depth of field “D2” and the second length “b2” in focus are corresponding to the second focal length. It is noted that “D2” relative to “b2” would meet or partially overlap with “D1” relative to “b1”.

Furthermore, in the embodiment, the first focal length is shorter than the second focal length. That is, the “negative out of focus module” executes capturing process by in-sequence selecting the lens with the shorter focal length. The selection of short focal length with the large depth of filed compensates for the loss in the depth of field due to the distance in focus with short distance. Alternatively, if the shorter focal length is selected for capturing first time, the “negative out of focus module” executes capturing process by in-sequence selecting the lens with the longer focal length. Alternatively, the “negative out of focus module” executes capturing process by selecting the lenses with short and long focal lengths.

For this reason, the FIG. 3C illustrates the above method for calculating different focus length and different depth of the field to obtain the focus length for the nth photographs. Capturing multitudes of photos in sequence is performed with the identical exposure value, the different length “bₙ” in focus, and the corresponding depth of field “Dn”, wherein n denotes the number of the capturing times, wherein the n is 1 to 5. It is noted that “Dn” relative to “bₙ” are capable of enclosing the distance “a1”, so that at least one photo with the definite topic object 32 is acquired. In the embodiment of the present invention, the number of photographs is determined according to the desired aperture. In generally, the number of photographs is about 2 through 5 sheets.

For example, when the distance between the topic object and the lens of the image-capturing device is 3 meters, the distance between the background object, Tokyo tower 34 and the lens of the image-capturing device 30 is 40 meters, an exposure value can be obtained by arithmetic unit within the image-capturing device 30, wherein the exposure value includes aperture is 4.0 and the camera shutter is 1/60 seconds. The user expects the topic object 32 as the focus point which the distance M1 between the topic object 32 and the lens of the image-capturing device 30 is 3 meters. Thus the overall rang of the depth of field ΔL, front depth of field ΔL₁ and back depth of field ΔL₂ can be obtained as following:
ΔL₁=(FδL²)/(f²+FδL)
ΔL₂=(FδL²)/(f²−FδL)
ΔL=ΔL₁+ΔL₂=(2f²FδL²)/(f⁴−F²δ²L²)
wherein the ΔL₁ denotes front depth of field, ΔL₂ denotes back depth of field, ΔL denotes overall depth of field, F denotes aperture of lens, f denotes focus length of lens, L denotes the focus length, and δ denotes the diameter of permission circle of confusion. The diameter of the permissible circle of confusion express the diameter of circle of confusion is less than the capability for determining by naked eyes of human being, the image of topic object 32 would be indefinite to determine in the range of the confusion circle. For example, the lens size of image-capturing device 30 is 4.35 mill-meters, and the diameter of permission circle of confusion is about 0.035 mill-meters.

Thus, according to above the formulas, the front depth of field, back depth of field, and the overall depth of field can be express during performing continuous capturing process as following:
ΔL_{1,n}=(FδL²)/(f²+FδL), n=1˜5
ΔL_{2,n}=(FδL²)/(f²−FδL), n=1˜5
ΔLₙ=ΔL_{1,n}+ΔL_{2,n}=(2f²FδL²)/(f⁴−F²δ²L²)
wherein the suffix 1 denotes the front depth of field, n denotes the number of capturing times, thus, ΔL_{1,n} can express the nth front depth of field after capturing process. On the other hand, the suffix 2 denotes the back depth of field, wherein n denotes the number of capturing times, thus, ΔL_{2,n} can express the nth back depth of field after capturing process.

According to above the formulas, the front depth of field ΔL_{1,1} is about 2.33 meter to 4.56 meter. Nevertheless, due to the out of focus problem, the topic object is Tokyo tower 34 not human being 32, thus, the first front depth of field ΔL_{1,1} is 32.82 meters, and the first back depth of field ΔL_{2,1} is 51.2 meters. The depth of field ΔL₁ is 84.02 meters, and the first depth of filed relative to the first distance in focus is in the range of about 7.1 meter to 91.2 meter. Because of the desired capturing topic object (human being 32) is not within the distance range of the first depth of field, so that the photograph cannot show the definition image of topic object 32 after developing process. Herein, the distance range of first depth of field is the distance between the lens of image-capturing device 30 to the first front depth of field and the distance between the lens of image-capturing device to the first back depth of field.

Thus, according to above the formulas, with the identical exposure value, the second distance in focus is acquired 4 meters. Thus, the second front depth of field is 1.25 meters and second back depth of field is 3.37 meters. Thus, the second depth of field is about 4.62 meters, and the second depth of filed relative to the second distance in focus is in the range of about 2.74 meters to 7.36 meters. It is noted that the second depth of filed relative to the second distance in focus overlaps with the first depth of filed relative to the first distance in focus. Next, the third front depth of field ΔL_{3, 1} is about 0.41 meters and third back depth of field ΔL_{3, 2} is about 0.66. Thus, the third depth of filed is about 1.07 meters, and the third depth of filed relative to the third distance in focus is in the range of about 1.69 meters to 2.76 meters. Therefore, three photos are captured with the distances in focus “b1”, “b2”, and “b3” respectively and the identical exposure value. Those three photos have same exposure value and have different focus length to include the overall distance range of different depth of focus that between the topic object 32 and background object 34. Thus, at least one of the three photos of topic object is clearly after developing process.

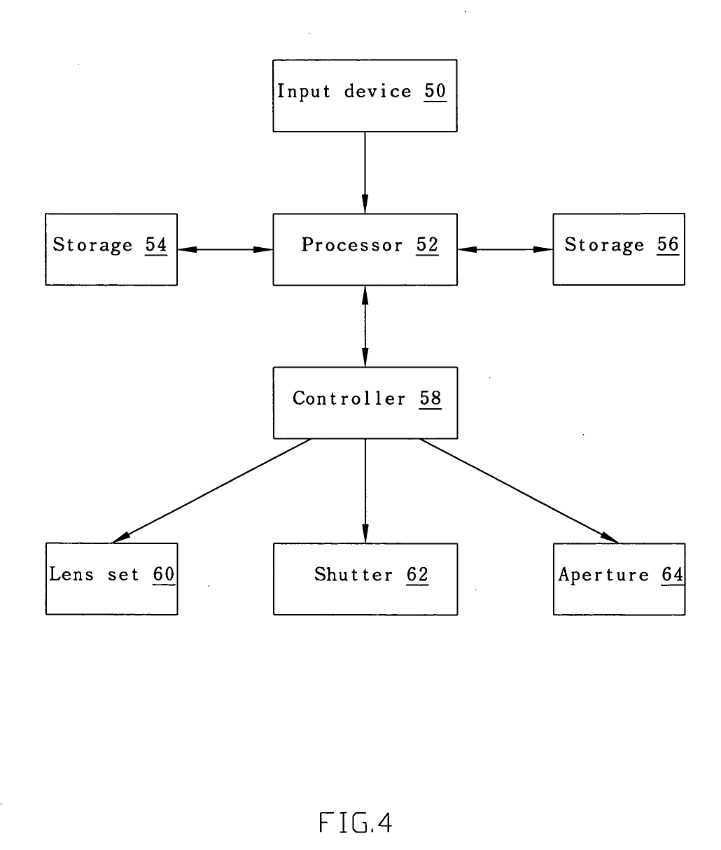

FIG.4 is a schematic block diagram illustrating an image-capturing device in accordance with the present invention. In an embodiment, image-capturing device includes an input device 50, a processor 52, a controller 58, storages 54 and 56, and a capturing device such as lens set 60, shutter 62, and aperture 64, and so on. The input device 50 includes function knobs and keys. In the embodiment, the input device 50 includes the item of “negative out of focus module”. The processor 52 processes the information from the input device 50 and the controller 58 for operation or settings. In the embodiment, the processor 52 includes receives the request for “negative out of focus module” and process the operation of the image-capturing. The controller 58 receives the settings from the processor 52 and controls the action and period of the capture device, such as selecting the lens set 60, controlling the rate of the shutter 62 and the size of the aperture 64. The storage 56, such as film or memory, is configured for recording the captured image information.

The storage 54, configured for storing the readable programs for “negative out of focus module”, also can be built in the memory of the processor 52. In association with the storage 54, the processor 52 is capable of processing the settings for execution of “negative out of focus module” and then outputs the settings to the controller 58. Accordingly, once user selects the “negative out of focus module” by the input device 50, the image-capturing automatically multitudes of films for capturing the film in focus.

Furthermore, it is noted that the exposure value within the image-capturing device is changed as follow the light condition (a sunny day or a rainy day). The detecting light system within the image-capturing device would estimate the exposure value according to the calculation method. Then, according to the fix exposure value, different focus length and different depth of field to obtain at least one photograph that can show the clear image of topic object.

Although specific embodiments have been illustrated and described, it will be obvious to those skilled in the art that various modifications may be made without departing from what is intended to be limited solely by the appended claims.

1. A method for capturing negative out of focus, said method comprises:
(a) providing a topic object and a background object;
(b) capturing a first photo, according to a first distance in focus to said background object, said first photo includes said topic object and said background object, wherein said first distance in focus corresponds to an exposure value and a first depth of field;
(c) acquiring a second distance in focus, wherein said second distance in focus corresponds to said exposure value and a second depth of field, and said second depth of field relative to said second distance in focus overlaps a partial portion of said first depth of field relative to said first distance in focus;
(d) capturing a second photo, according to said second distance in focus, said second photo includes said topic object and said background object; and
(e) replacing said first distance in focus with said second distance in focus, and repeating step (c) and step (d) till said topic object within said second depth of field relative to said second distance in focus.

2. The method according to claim 1, wherein said first depth of field is calculated from said first distance in focus, a first front depth of field, and a first back depth of field.

3. The method according to claim 2, wherein said first front depth of field is a distance of a first near point in front of said background object.

4. The method according to claim 2, wherein said first back depth field is a distance of a far point in back of said background object.

5. The method according to claim 1, wherein said second depth of field is calculated from said second distance in focus, a second front depth of field, and a second back depth of field.

6. The method according to claim 5, wherein said second front depth of field is a distance of a second near point in front of said background object.

7. The method according to claim 5, wherein said second back depth of field is a distance of a second far point in back of said background object.

8. A method for capturing in-focus, said method comprises:
providing a topic object and a background object; and
capturing number of photos, said number of photos correspond an exposure value, one of said number of images includes said topic object and said background object based on a distance in focus, each distance in focus correspond to a depth of field, wherein
each said depth of field relative to said corresponding distance in focus overlapping partial portion of other said depth of field relative to other said distance in focus, said topic object within one of said depth of field relative to said corresponding distance in focus.

9. The method according to claim 8, wherein said depth of field is calculated from said depth of field correspond to said distance in focus, a front depth of field, and a back depth of field.

10. The method according to claim 9, wherein said front depth of field is a distance of a near point in front of said background object.

11. The method according to claim 9, wherein said back depth of field is a distance of a far point in back of said background object.

12. An image-capturing device with a negative out of focus module, said image-capturing device comprising:
an input device, for inputting an item of said negative out of focus module;
a storage, for storing a plurality of programs for said negative out of focus module;
a processor, according to the item of said negative out of focus module and said programs, outputting a command of executing said negative out of focus module, said command comprising the step of capturing number of photos, said number of photos corresponding an exposure value, one of said number of images including said topic object and said background object based on a distance in focus, each distance in focus correspond to a depth of field, wherein each said depth of field relative to said corresponding distance in focus overlapping partial portion of other said depth of field relative to other said distance in focus, said topic object within one of said depth of field relative to said corresponding distance in focus.
a capturing device, for performing said command; and
a controller, for receiving said command and control said capturing device in accordance with said command.

13. The image-capturing device with a negative out of focus module according to claim 12, wherein said storage, used for storing a plurality of readable programs capable of capturing a plurality of photos by an image-capturing device, said readable programs enabling the image-capturing device executing the steps:
(a) capturing a first photo, according to a first distance in focus to a background object, said first photo includes a topic object and said background object, wherein said first distance in focus corresponds to an exposure value and a first depth of field;
(b) acquiring a second distance in focus, wherein said second distance in focus corresponds to said exposure value and a second depth of field, and said second depth of field relative to said second distance in focus overlaps a partial portion of said first depth of field relative to said first distance in focus;
(c) capturing a second photo, according to said second distance in focus, said second photo includes said topic object and said background object; and
(d) replacing said first distance in focus with said second distance in focus, and repeating step (b) and step (c) till said topic object within said second depth of field relative to said second distance in focus.
